(19) United States
(12) Patent Application Publication
(10) Pub. No.: US 2020/0407137 A1
(43) Pub. Date: Dec. 31, 2020

(54) BAGS-IN-BAG PACKAGING SYSTEM

(71) Applicant: DSM IP ASSETS B.V., HEERLEN (NL)

(72) Inventors: Jihane ACHKAR, Kaiseraugst (CH); Andrea BULBARELLO, Kaiseraugst (CH); Alan CONNOLLY, Kaiseraugst (CH)

(21) Appl. No.: 16/977,301

(22) PCT Filed: Mar. 14, 2019
(86) PCT No.: PCT/EP2019/056441

§ 371 Date: Sep. 1, 2020

(30) Foreign Application Priority Data
Mar. 15, 2018 (EP) 18162021.2

(51) Int. Cl. B65D 65/46; B65D 77/04

(52) U.S. Cl. CPC B65D 65/466; B65D 81/2084; B65D 77/04

(57) ABSTRACT

The present invention relates to a bags-in-bag packaging system, wherein the inner bags (2) are made of biodegradable and/or compostable packaging material. Good storage stability and long shelf-life is achieved even if the inner bags (2) enclose an oxidable compound such as vitamin A. The inner bags (2) are preferably single-serve sachets comprising sufficient vitamins and minerals for effectively fight micronutrient deficiency.

### TECHNICAL FIELD

The present invention relates to littering caused by single-serve sachets and stick packs. It also relates to the packaging of oxidable products such as vitamin A.

### BACKGROUND OF THE INVENTION

Compositions comprising vitamins often require extensive packaging. This is particularly true for extrudates comprising vitamin A. Vitamin A is sensitive to oxygen.

Extrudates comprising vitamins and minerals may be given to people suffering from micronutrient deficiency. Micronutrient deficiency is also referred to as “hidden hunger”.

Typically, such extrudates have a particle size from 205 μm to 1000 μm. Thus, they are too small to be packaged in blisters. Bottles aren't an option either. When the bottle is opened, its content is fully exposed to oxygen. In-use-stability of such bottles is low.

Presently, bags having aluminum layers are the favorite packaging solution for oxidable products. Commercially available vitamin powders are sold as single-serve sachets which comprise aluminum laminates.

Single-serve sachets with aluminum layers have good storage stability and thus, sufficiently long shelf-life. However, they also have significant disadvantages. Single-serve sachets are more expensive compared to a larger size package and, most importantly, they keep growing the world's waste mountain. Waste issues triggered by single-serve products (such as single-serve coffee containers) are being widely discussed.

There is an urgent need to fight hidden hunger in a more sustainable, ecological manner.

Waste management by composting is discussed in a “STUDY ON SOLID WASTE MANAGEMENT OPTIONS FOR AFRICA” (2002), prepared for the

African Development Bank, Sustainable Development & Poverty Reduction Unit, Abidjan, prepared by Richard J. Palczynski, Canada.

US 2010/0272868 discloses a multi-chambered food container to separate drugs that may adversely interact with each other during storage.

EP 0 442 659 B1 discloses a package whose inner bag is ruptured by application of an external pressure only with fingers.

EP 0 719 715 B1 discloses a double package whose inner container has a water vapor permeability of 44g/m².

### SUMMARY OF THE INVENTION

The problem to be solved by the present invention is reducing the impact of littering caused by single-serve bags (also referred to as “sachets”) containing at least one oxidable product. A more specific problem to be solved is reducing waste when packaging extrudates comprising a daily portion of an oxidable vitamin.

Extrudates comprising oxidable vitamins may be used to fight hidden hunger in sub-Saharan Africa. Thus, a problem also underlying the present invention is reducing waste and the effects of littering in sub-Saharan Africa when fighting hidden hunger.

The present invention discloses two synergistically interacting approaches:
reducing the volume of the product: less volume requires less packaging; commercially available powders often comprise significant amounts of fillers.
using biodegradable or compostable packaging material

However, implementation of these two approaches (separate or in combination) is far from being easy.

Vitamin A products packaged in biodegradable or compostable packaging material have an insufficient shelf-life. This is particularly true for climate zone III, IVa or IVb storage stability (cf. current definition of ICH stability zones for stability studies). This is a particular challenge as there is a big demand for vitamin A containing products in sub-Saharan countries: to fight micronutrient deficiency, hundreds of even thousands of single-serve bags are given to African school children every day. So far, it has been impossible to manufacture biodegradable or compostable single-serve bags that have a sufficient shelf-life in sub-Saharan Africa.

Reducing the volume of the product is not easy either: the reduction of adjuvants such (as colloids and fillers) often has a detrimental effect on storage stability of oxidable compounds.

The problems underlying the present invention are solved by a product as defined in the claims. Said product comprises or consists of an outer bag having a plurality of inner bags sealed therein, wherein said inner bags are made of bio-degradable and/or compostable packaging material and wherein said inner bags enclose at least one oxidable compound (“bags-in-bag packaging system”). In a preferred embodiment, the inner bags comprise highly concentrated extrudates, i.e. extrudates with a reduced volume.

The bags-in-bag packaging system of the present invention provides for excellent storage stability even though the inner, degradable and/or compostable bags may have a certain permeability to water and oxygen. The latter is acceptable because most of the inner bags are distributed and consumed within 1 day.

In a typical situation, the teacher of an African village school opens the outer bag and distributes the inner bags to the children of his school. The children then consume the content of the inner bag on the same day, either at home or at school. Consumption at school typically takes place where the school offers free lunch to the children.

Whereas the school reuses the outer bag or takes care of proper disposal of the outer bag, some of the inner bags may be thrown on a dirt road or somewhere else. This kind of littering, however, is no longer an issue because the inner bag is made of biodegradable or compostable packaging material. Microorganisms make biodegradable or compostable bags disappear within a reasonable time.

### DETAILED DESCRIPTION OF THE INVENTION

The present invention relates to bags made of biodegradable and/or compostable packaging material.

The context of the present invention, the term “bag” refers to a flexible container, such as a foil bag. Said foil may be a flexible laminate. At the top, the bag of the invention has an opening which is sealed. Different kinds of seal might be used. In one embodiment, a reusable zip lock is used. In a preferred embodiment, however, the bag is a heat sealable bag.

Any commercially available biodegradable and/or compostable packaging material may be used. Preferred biodegradable and/or compostable packaging material comprises modified or unmodified polylactic acid (PLA). Particularly preferred is paper coated with PLA. Also preferred are starch-based biodegradable films comprising a modified polylactic acid. Such a film is disclosed in CN107417982.

Biodegradation is a biochemically induced process. In the context of the present invention, packaging material is “biodegradable” when at least 80 weight-%, preferably at least 85 weight-% and most preferably at least 90 weight-% of the packaging material (based on the total weight of the packaging material) can be metabolized with the help of microorganisms into water, carbon dioxide, and biomass.

In the context of the present invention, the term “compostable” relates to packaging material that meets the requirements of the European standard EN 13432 “Requirements for packaging recoverable through composting and biodegradation”.

Unfortunately, currently available biodegradable and compostable packaging materials have a certain permeability to water and/or oxygen. Therefore, shelf-life of oxidable compounds is insufficient when packaged with biodegradable or compostable packaging material.

Aluminum foil is impermeable to water and oxygen, but it is neither biodegradable nor compostable.

In the context of the present invention, the term “oxidable compound” refers to a preferably edible compound which can no longer be sold to a consumer (due to oxidative changes in its color, taste, texture and/or nutritional value) after having been exposed to air for 24 hours at 20° C. and 50% relative humidity. In a preferred embodiment of the present invention, the term “oxidable compound” refers to an edible compound such as an oxidable vitamin. In an even more preferred embodiment of the present invention, the term “oxidable compound” refers to vitamin A or a derivative of vitamin A such as a vitamin A ester. In the most preferred embodiment of the present invention, the term “oxidable compound” refers to vitamin A palmitate.

Packaging System

The drawbacks of biodegradable and compostable packaging materials can be overcome by providing a product that comprises or consists of an outer bag having a plurality of (i.e. at least two) inner bags sealed therein, wherein said inner bags are made of biodegradable and/or compostable packaging material and wherein each of said inner bags has at least one oxidable compound sealed therein.

Thus, the present invention relates to a “bags-in-bag packaging system”, wherein the outer bag comprises at least two inner bags. Said inner bags are detached from the outer bag such that one or multiple inner bags can be taken out of the opened outer bag without using a knife or any other kind of instrument.

The outer bag comprises a plurality of inner bags. The more inner bags are sealed in the outer bag, the more sustainable the packaging solution is (cf. examples). Thus, in a preferred embodiment, the outer bag according to the present invention comprises at least 10, preferably at least 50 inner bags and/or the ratio between the weight of the empty outer bag and the total weight of the empty inner bags is less than 2:1 and is preferably from 1:1 to 1:50.

“Sealed” as used in the context of the present invention means that the packaging material of the outer bag is joined together to form a closed container so as to prevent liquid water from passing through the seal into the bag and vice versa. Preferably, “sealed” means “hermetically sealed”. “Hermetically sealed” means any type of sealing that makes the seal airtight, excluding passage of air through the seal into the bag and vice versa.

Thus, a preferred embodiment of the invention relates to an outer bag having a plurality of inner bags hermetically sealed therein, wherein said inner bags are made of biodegradable and/or compostable packaging material, and wherein each of said inner bags has at least one oxidable compound hermetically sealed therein.

The packaging system of the present invention allows to store an oxidable compound for many months or years, even in climate zones III, IVa and/or IVb. This is surprising if one considers that a large part of the packaging system is biodegradable and/or compostable.

Shelf-life of the oxidable compounds can be further improved if the atmosphere within the sealed outer bag (also referred to as headspace atmosphere) comprises less than 10 vol.-% oxygen, preferably less than 5 vol.-% oxygen, more preferably less than 1 vol.-% oxygen and most preferably less than 0.1 vol.-% oxygen. This is referred to as modified atmosphere packaging (MAP). For checking the oxygen content, a mobile headspace gas analyzer such as OXYBABY® 6.0 O2 (commercially available at wittgas.com) can be used. MAP can be achieved by a method comprising the steps:
filling a plurality of inner bags into an outer bag and optionally purging said outer bag with a protective gas such as nitrogen
sealing said outer bag.

In said method, the outer bag can be purged with a protective gas before and/or after filling the inner bags into the outer bag. Preferably, however, the outer bag is purged with a protective gas after having filled the inner bags into the outer bag.

In a less preferred embodiment, protective gas is replaced by vacuum.
In a preferred embodiment, the method comprises the steps:
purging the inner bags with a protective gas such as nitrogen
filling at least one oxidable compound in each of said inner bags
sealing said inner bags to form a plurality of inner bags
purging an outer bag with a protective gas such as nitrogen
filling a plurality of inner bags in said outer bag
sealing said outer bag.

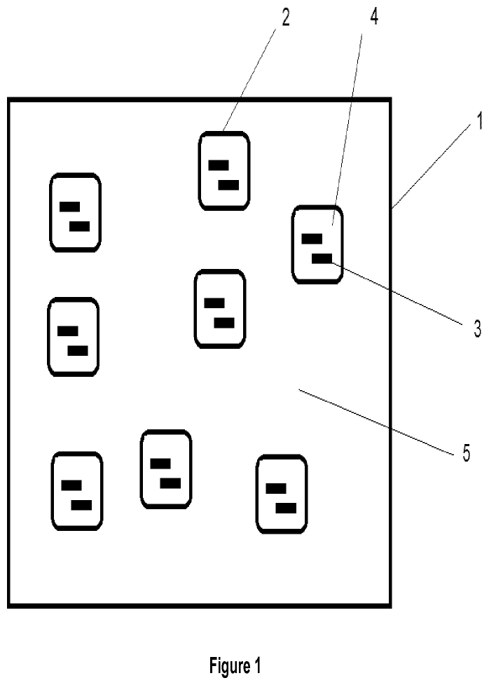

FIG. 1 shows schematically an example of the present invention. Outer bag (1) comprises eight inner bags (2). Each of the inner bags (2) encloses two extrudates (3), each of said extrudates comprising at least one oxidable compound (not shown in FIG. 1). Outer bag (1) encloses inner bags (2) and a protective gas (5) such as nitrogen. This also applies to the plurality of inner bags: each inner bag (2) encloses extrudates (3) and protective gas (4), such as nitrogen. Inner bags (2) are made of biodegradable and/or compostable packaging material. Outer bag (1) may be reusable, recycle or resealable.

### OUTER BAG

Shelf-life of the packaging system of the invention is particularly long if the outer bag is made of packaging material which has a low oxygen transmission rate (OTR) and/or a low water vapor transmission rate (WVTR). In a preferred embodiment, said packaging material has both, a low OTR and a low WVTR. In the most preferred embodiment, the outer bag is made of packaging material having the status “total barrier”.

Packaging material having the status of “total barrier” is completely impermeable to water and oxygen. An example of such a material is aluminum foil (if free of pinholes). Thus, any material performing as good as or better than pinhole free aluminum foil when applying the “Whole bag method for determining oxygen transmission rate” can be used (Moyls, A. L., Transactions of the American Society of Agricultural Engineers, January 2004, 47(1):159-164) is considered as having that status “total barrier”.

In one embodiment of the invention, the outer bag of the invention is made of packaging material having an oxygen transmission rate (OTR) of less than 1, preferably less than 0.5 cm³/cm² for 24 hours at 23° C. and 0% relative humidity (RH; dry conditions) and/or having a water vapor transmission rate (WVTR) of less than 1, preferably less than 0.5 g/m² for 24 hours at 38° C. and 90% relative humidity.

Oxygen permeability testing is preferably made in accordance with ASTM D-3985 e.g. by using MOCON OX-TRAN 2/21 equipment.

Water vapor transmission rate testing is preferably made in accordance with ASTM F1249 e.g. by using MOCON PERMATRANW 3/33.

After usage, the outer bag can be disposed. However, in a preferred embodiment of the invention, the outer bag is reusable, recyclable, and/or resealable. In the most preferable embodiment, the outer bag is manually resealable or is resealable by using a portable sealing machine.

Inner Bags

The present invention also relates to an intermediate product, i.e. to bags made of biodegradable and/or compostable packaging material, wherein each of said bags encloses at least one oxidable compound such as vitamin A or an ester of vitamin A.

The finished product (i.e. the bags-in-bag packaging system of the invention) comprises a plurality of these bags. Therefore, these bags are also referred to as “inner bags”.

In a preferred embodiment of the invention, each of said inner bags encloses multiple extrudates. In one embodiment, each of said inner bags encloses more than 200 extrudates, wherein each extrudate has a particle size from 205 μm to 1000 μm (measured by sieving).

The composition of each extrudate might be identical. However, in a preferred embodiment of the invention, each of said inner bags encloses different kind of extrudates. One kind of extrudate may comprise fat-soluble vitamins (such as vitamin A) whereas another kind of extrudates may comprise water-soluble vitamins. A yet other kind of extrudate may comprise minerals.

In a preferred embodiment of the invention, each of said inner bags contains the recommended daily intake (RDI) of at least three, preferably at least five vitamins, and/or of at least three, preferably at least five minerals. With such a product, hidden hunger can be treated very effectively.

In the context of the present invention, the “recommended daily intake (RDI)” is the RDI for infants, children or adults according to the dietary guidelines by the Food and Nutrition Board of the Institute of Medicine, National Academy of Sciences. From time to time, said guidelines are being updated. In the context of the present invention, the version which was in force on Jan. 1, 2018 is meant.

The person skilled in the art understands that a certain deviation from the recommended daily intake (RDI) is acceptable. Thus, the present invention also relates to a plurality of bags, wherein each bag contains at least 80% of the recommended daily intake (RDI) of
at least three, preferably at least four and most preferably at least five vitamins, and
at least three, preferably at least four and most preferably at least five minerals,

wherein said recommended daily intake (RDI) is the RDI for infants, children or adults according to the dietary guidelines by the Food and Nutrition Board of the Institute of Medicine, National Academy of Sciences, said guidelines being in force on Jan. 1, 2018.

Presently available products for fighting hidden hunger in sub-Saharan Africa contain vitamin powder. The advantage of using extrudates instead of a powder is a reduction in volume. Conventional powders containing the recommended daily intake (RDI) of A, E, D3, riboflavin, folic acid, C, niacinamide, B12, thiamine vitamins, iron, copper, calcium, zinc and selenium have a volume of up to 10 cm³.

In contrast, extrudates containing the recommended daily intake (RDI) of vitamins A, E, D3, riboflavin, folic acid, C, niacinamide, B12, thiamine vitamins, iron, copper, calcium, zinc and selenium have a volume of less than 1 cm³. This volume reduction allows to reduce the amount of packaging by at least 50% (cf. example). Such extrudates can be manufactured as disclosed in WO 2017/060320.

Thus, the present invention also relates to a plurality of bags, wherein each of said bags encloses multiple extrudates, and wherein 2.7 g of said extrudates have a volume of less than 10 cm³, preferably of less than 5 cm³. Comparable products currently available on the market contain approx. 8 g powder.

Synergism

Hidden hunger is fought in the most sustainable manner if extrudates having a small volume are packaged in the bags-in-bag packaging system of the present invention: less packaging waste is produced and what is produced is either biodegradable/compostable or reusable/recyclable.

### Example 1 (Bags-in-Bag Packaging System)

Oxygen transmission rate (OTR) of several 3D samples (i.e. bags) were evaluated by the Standard Test Method ASTM D3985 at 23° C. and 0% RH (dry conditions). The 3D samples were mounted on a sample holder specific for 3D samples. After a conditioning step of 24 hours, the measurement phase took place at a carrier gas flux of 70 mL/min (low conditioning).

As a result of this evaluation, an outer bag having an oxygen Transmission Rate (OTR) of less than 0.5 cm³/cm² was chosen (supplier A. Hatzopoulos, S. A. Greece).

In a second step, compositions comprising oxidable vitamin A were packed in various biodegradable and/or compostable bags (commercially available). Experiments showed that none of the tested packaging material allows to manufacture a product with sufficient shelf-life. After 6 months storage under controlled conditions, less than 50% of the original amount of vitamin A was recoverable when using commercially available biodegradable and/or compostable bags (no MAP). Using a Modified Atmosphere Packaging (MAP; e.g. nitrogen gas) improved per se stability, but not to a sufficient degree.

To improve stability, the oxidable compounds are packed in biodegradable and/or compostable bags (preferably MAP). Multiple of said biodegradable and/or compostable bags are then packed into an outer bag having an oxygen Transmission Rate (OTR) of less than 0.5 cm⁻³/cm⁻² (preferably also MAP).

### Example 2 (Optimization of Inner Bag)

The volume of daily portion of commercially available MixMe® (supplier: DSM

Nutritional Products) has been measured. MixMe® is a conventional micronutrient powder (i.e. no extrudates).

As a comparison, the volume of daily portion of an improved version of MixMe® has been measured. Said daily portion comprises the same amount of micronutrients as in the daily portion of commercially available MixMe®. Such extrudates can be manufactured as disclosed in WO 2017/060320.

Because the improved version of MixMe® is made of extrudates instead of powders, a significant volume reduction could be achieved. Said volume reduction allowed to reduce the amount of packaging. Details are given in below table:

| Volume of a daily | Volume of a daily |
|---|---|
| portion MixMe ® | portion improved |
| (powder) | MixMe ® (extrudates) |
| 1.3 cm³ | 0.22 cm³ |

given surface-to-volume ratio¹⁾ = 25 cm⁻¹

| Packaging material in | Packaging material in |
|---|---|
| cm² for daily | cm² for daily |
| portion MixMe ® | portion improved MixMe ® |
| 25 cm⁻¹ · | 25 cm⁻¹ · |
| 1.32 cm³ = 33 cm² | 0.22 cm³ = 5.5 cm² |

¹⁾The surface-to-volume ratio depends on the shape of the packaging (cube, sphere, cone etc.) A lower surface-to-volume ratio means that packaging is more efficient: it takes less packaging material to hold just as much stuff.

Thus, the measured volume reduction of 6 times led up to 83% less packaging.

### Example 3 (Optimization of Bags-in-Bag Packaging System)

The inner bags of the invention's bags-in-bag packaging system are made of biodegradable packaging material whereas the outer bag's packaging material typically contains an aluminum layer to reach the status “total barrier”. Littering of biodegradable packaging material is doing less damage than littering of aluminum. Aluminum is not degrading over time.

Thus, to get a sustainable packaging system, the ratio between the weight of the empty outer bag and the total weight of the empty inner bags should be as small as possible.

To improve sustainability, the following optimization has been considered:

| Weight of the | 12 g | Weight of 1 empty | 0.3 g | | |
|---|---|---|---|---|---|
| outer empty bag | | inner bag | | | |
| | | Weight of 10 empty | 3 g | | |
| | | inner bags | | | |
| | | Weight of 100 empty | 30 g | | |
| | | inner bags | | | |
| | | | | | Impact of |
| | | | | | littering |
| Packaging | 1 outer | 12 g non- | ratio between | 12 g:0.3 g = | high |
| system 1 | bag | biodegradable | the weight of the | 40:1 | |
| | | packaging material | empty outer bag | | |
| | 1 inner | 0.3 g biodegradable | and the total | | |
| | bag | packaging material | weight of the | | |
| | | | empty inner bags | | |
| Packaging | 1 outer | 12 g non- | ratio between | 12 g:3 g = | medium |
| system 2 | bag | biodegradable | the weight of the | 4:1 | |
| | | packaging material | empty outer bag | | |
| | 10 inner | 3 g biodegradable | and the total | | |
| | bags | packaging material | weight of the | | |
| | | | empty inner bags | | |
| Packaging | 1 outer | 12 g non- | ratio between | 12 g:30 g = | low |
| system 3 | bag | biodegradable | the weight of the | 0.4:1 | |
| | | packaging material | empty outer bag | | |
| | 100 inner | 30 g biodegradable | and the total | | |
| | bags | packaging material | weight of the | | |
| | | | empty inner bags | | |

Example 3 shows that harmful littering can be reduced when more inner (biodegradable) bags are put into the outer (non-biodegradable) bag.

To do so, the inner bags must be small. Smaller bags are achievable when the composition to be packaged requires less volume. Less volume can be achieved by manufacturing extrudates instead of powders (cf. example 2).

1. Outer bag having a plurality of inner bags sealed therein, wherein said inner bags are made of biodegradable and/or compostable packaging material, and wherein each of said inner bags has at least one oxidable compound sealed therein.

2. Outer bag according to claim 1, wherein said outer bag is made of packaging material having an oxygen transmission rate (OTR) of less than 1 cm³/cm² for 24 hours at 23° C. and 50% relative humidity and/or wherein said outer bag is made of packaging material having a water vapor transmission rate (WVTR) of less than 1 g/m² for 24 hours at 38° C. and 90% relative humidity.

3. Outer bag according to claim 1, wherein said outer bag comprises at least 10, preferably at least 50 inner bags and/or wherein the ratio between the weight of the empty outer bag and the total weight of the empty inner bags is less than 2:1 and is preferably from 1:1 to 1:50.

4. Outer bag according to claim 1, wherein the air in said outer bag comprises less than 10 vol.-%, preferably less than 5 vol.-% oxygen gas and/or wherein each of said inner bags comprises less than 10 vol.-%, preferably less than 5 vol.-% oxygen gas.

5. Outer bag according to claim 1, wherein said outer bag is reusable, recyclable, and/or resealable, preferably by using a portable sealing machine.

6. Plurality of bags, wherein each of said bags is made of biodegradable and/or compostable packaging material, and wherein each of said bags has multiple extrudates sealed therein, said extrudates comprising at least one oxidable compound such as vitamin A or an ester of vitamin A.

7. Plurality of bags according to claim 6, wherein 2.7 g of said extrudates have a volume of less than 10 cm³, preferably of less than 5 cm³.

8. Plurality of bags according to claim 6, wherein each bag contains at least 80% of the recommended daily intake (RDI) of
at least three, preferably at least four and most preferably at least five vitamins, and
at least three, preferably at least four and most preferably at least five minerals, wherein said recommended daily intake (RDI) is the RDI for infants, children or adults according to the dietary guidelines by the Food and Nutrition Board of the Institute of Medicine, National Academy of Sciences, said guidelines being in force on Jan. 1, 2018.

9. Outer bag according to claim 1, wherein said inner bags are made of biodegradable and/or compostable packaging material, and wherein each of said bags has multiple extrudates sealed therein, said extrudates comprising at least one oxidable compound such as vitamin A or an ester of vitamin A.

10. Use of biodegradable and/or compostable packaging material for manufacturing a plurality of bags, wherein said plurality of bags is sealed in an outer bag.

11. Use according to claim 10, wherein said biodegradable and/or compostable packaging material comprises modified or unmodified polylactic acid (PLA) such as paper coated with PLA.

12. Use according to claim 10, wherein said plurality of bags are made of biodegradable and/or compostable packaging material, and wherein each of said bags has multiple extrudates sealed therein, said extrudates comprising at least one oxidable compound such as vitamin A or an ester of vitamin A.

13. Method for packaging at least one oxidable compound, said method comprising the steps:
filling a plurality of inner bags in an outer bag and optionally purging said outer bag with a protective gas
sealing said outer bag wherein said inner bags are made of biodegradable and/or compostable packaging material and wherein each of said inner bags has at least one oxidable compound sealed therein.

14. Method according to claim 13, wherein each of said plurality of inner bags has multiple extrudates sealed therein, said extrudates comprising at least one oxidable compound such as vitamin A or an ester of vitamin A.
